(19) United States
(12) Patent Application Publication
(10) Pub. No.: US 2007/0272083 A1
(43) Pub. Date: Nov. 29, 2007

(54) FILTER SATURATION CONTROL SYSTEM

(76) Inventors: Ross HOGE, Kirkland (CA); Louis Dupuis, St-Polycarpe (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/694,003

(22) Filed: Mar. 30, 2007

Related U.S. Application Data
(60) Provisional application No. 60/787,176, filed on Mar. 30, 2006.

(51) Int. Cl. B01D 46/00

(52) U.S. Cl. 96/417; 73/865

(57) ABSTRACT

A system for determining a level of saturation of a VOC filter in a filtering apparatus, including a weight sensor for sensing a weight of at least a portion of the filtering apparatus including the VOC filter and for producing a corresponding weight signal, a weight calculator for determining an actual weight of the VOC filter based on the weight signal and for producing corresponding actual weight data, a saturation interpreter for determining the level of saturation of the VOC filter based on a comparison between the actual weight data and benchmark weight data, and an interface for providing an indication of the level of saturation.

### CROSS-REFERENCE TO RELATED APPLICATION

This patent application claims priority on U.S. Provisional Patent Application No. 60/787,176, filed on Mar. 30, 2006.

### BACKGROUND OF THE INVENTION

1. Field of the Invention

The present invention relates to filtration apparatuses for volatile organic compounds (VOCs) and, more particularly, to filter replacement and maintenance indicators in such VOC filtration apparatuses.

2. Background Art

Filters are used in various industries to remove pollutants from air. Volatile organic compounds (hereinafter VOCs) are pollutants present in industries in which solvents are used. For instance, the ink used in the printing industry often is a source of VOC emissions, resulting from the high solvent to pigment ratio of the ink.

As VOCs are often in a gaseous state, mechanical filters are inefficient in filtering out VOCS, as such mechanical filters operate by mechanical interference and are thus used with solid pollutants (e.g., dust). Activated carbon filters and the like (hereinafter VOC filters) are therefore used to adsorb VOCs.

One of the issues associated with VOC filters is that it is difficult to determine when they are saturated to the level at which they become ineffective at reducing the concentration of the VOCs to the designed adsorption efficiencies of filtration apparatus and filter. Determination of the effectiveness of a VOC filter requires expensive instruments such as total hydrocarbon analyzers, PIDs (i.e., photo-ionization detectors) to measure the concentration of VOCs in the filtrate. Alternately, the filters or filter media may be sent to a laboratory for saturation analysis. However, this is a time consuming operation and destructive test. The calculation of pressure differential across the mechanical filters enables their saturation to be evaluated, but such a solution is not effective with VOC filters, as a saturated VOC filter is not necessarily obstructed mechanically to cause a pressure differential.

Manipulations of VOC filters are preferably minimized, considering the possible toxicity thereof. It is therefore preferred to avoid manipulations in the evaluation of saturation of such filters.

Prior art systems most often use a timer based system to estimate when a VOC filter is saturated. Time until saturation can vary hugely due to factors such as the concentration level of VOCs, the duty cycle of the machine, the process producing the VOCs and other like factors.

### SUMMARY OF INVENTION

It is therefore an aim of the present invention to provide a filter saturation control system that addresses issues associated with the prior art.

Therefore, in accordance with the present invention, there is provided a system to determine a level of saturation of a VOC filter in a filtering apparatus, comprising: a weight sensor to produce a weight signal associated with the VOC filter; a weight calculator connected to the weight sensor, the weight calculator providing an actual weight of the VOC filter from the weight signal; a database storing benchmark weight for the VOC filter; and a saturation interpreter connected to the weight calculator to determine a saturation level of the VOC filter as a function of the actual weight of the VOC filter and a benchmark weight; whereby the system indicates a saturation level for the VOC filter.

According to a further aspect of the system, the weight calculator provides weight increase rate measurements, and the saturation interpreter determines with the weight increase rate measurements whether a weight increase is associated with an increase in saturation of the filter.

Also in accordance with the present invention, there is provided a system for determining a level of saturation of a VOC filter in a filtering apparatus, comprising a weight sensor for sensing a weight of at least a portion of the filtering apparatus including the VOC filter and for producing a corresponding weight signal, a weight calculator for determining an actual weight of the VOC filter based on the weight signal and for producing corresponding actual weight data, a saturation interpreter for determining the level of saturation of the VOC filter based on a comparison between the actual weight data and benchmark weight data, and an interface for providing an indication of the level of saturation.

Also in accordance with the present invention, there is provided a method of determining a saturation level of a VOC filter in a filtering apparatus, the method comprising measuring an actual weight of the VOC filter, computing an actual weight difference between the actual weight and a benchmark weight, and determining the saturation level based on the actual weight difference.

Further in accordance with the present invention, there is provided a filtering apparatus comprising a body defining an inlet and an outlet, a flow inducer inducing an airflow in the body from the inlet to the outlet, a VOC filter located in the body such that the airflow circulates therethrough, a weight sensor measuring a weight of at least a portion of the filtering apparatus including the VOC filter and providing a corresponding weight measurement, a system determining a saturation level of the VOC filter based on the weight measurement, and an interface providing an indication of the saturation level.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a block diagram of a filter saturation control system in accordance with a first embodiment of the present invention;

FIG. 2 is an elevation view of a filtering apparatus using the filter saturation control system of FIG. 1; and

FIG. 3 is an enlarged perspective view of a weight sensor of the filter saturation control system, as positioned in the filtering apparatus.

### DESCRIPTION OF THE PREFERRED EMBODIMENTS

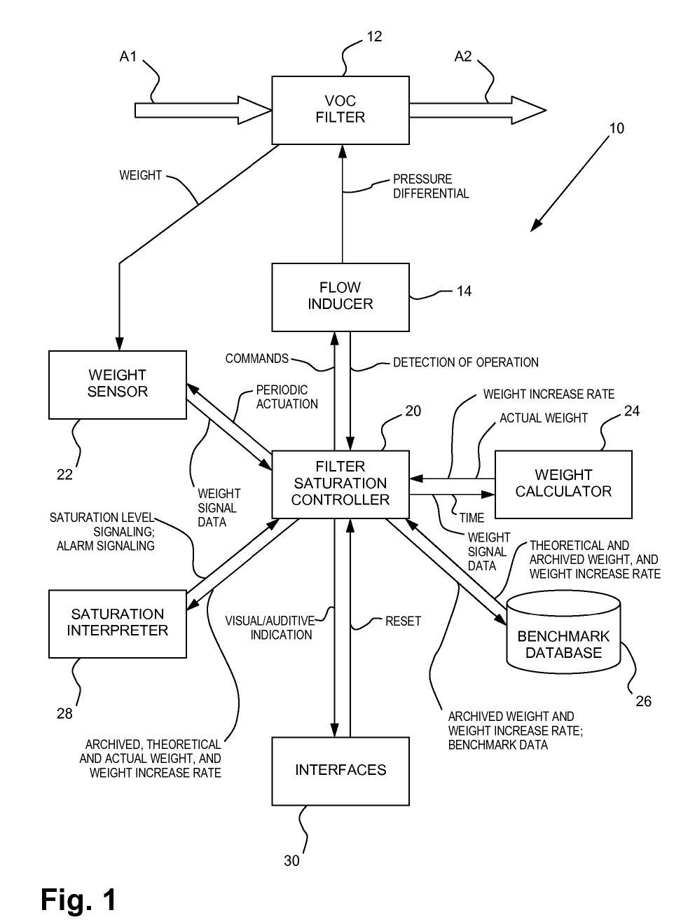

Referring now to FIG. 1, a filter saturation control system in accordance with the first embodiment is generally shown at 10. The filter saturation control system 10 is used with a filtering apparatus having a VOC filter 12 (i.e., activated carbon filter) associated with a flow inducer 14.

The VOC filter 12 is provided to absorb VOCs. The VOC filter 12 has an activated carbon bed (or similar filtration material) through which an air flow with VOCs is circulated.

A typical VOC filter 12 has charcoal (i.e., carbon). Activated charcoal is charcoal that has been treated with oxygen to open up millions of tiny pores between the carbon atoms. Accordingly, special manufacturing techniques results in highly porous charcoals with large surface areas for weight (e.g., 300-2,000 square metres per gram). Such active, or activated, charcoals are widely used to adsorb odorous or coloured substances from gases or liquids.

The VOCs are adsorbed by the activated carbon/charcoal (i.e., the VOCs attach to the carbon/charcoal by chemical attraction). The relatively large surface area of activated carbon/charcoal gives same a plurality of bonding sites for the VOCs. When they pass next to the carbon surface, VOCs attach to the surface of carbon/charcoal and are trapped (i.e., adsorbed). Activated charcoal is efficient at trapping other carbon-based impurities (e.g., organic chemicals), as well as elements like chlorine.

Once all of the bonding sites are filled, an activated carbon/charcoal filter stops working, and must be replaced. During adsorption, the carbon filter is increasing its weight. Experimentation typically enables to determine how much VOCs are adsorbed (their weight) before the filter is saturated.

The flow inducer 14 is associated with the VOC filter 12 so as to induce a flow of air through the VOC filter 12. The flow inducer 14 may take various forms/configurations, such as a blower, a fan, a pump, etc. By the actuation of the flow inducer 14, an inflow of air A1 with VOCs is fed to the VOC filter 12. Air exits the filter at A2 with a substantial portion of VOCs removed therefrom.

The filter saturation control system 10 has a filter saturation controller 20, which is part of a processing unit provided for the actuation and control of the filtering apparatus. The filter saturation controller 20 coordinates the various hardware and software components of the filter saturation control system 10.

The controller 20 is connected to the flow inducer 14, so as to detect when the flow inducer 14 is turned on. This information will be used to command the system 10 in performing measurements of the saturation of the VOC filter 12.

A weight sensor 22 is positioned in the filtering apparatus to produce a signal associated with the weight of the VOC filter 12 or the weight of the filter and the entire machine. The type of sensor used and its location in the filtering apparatus will be described in further detail hereinafter.

The weight sensor 22 is connected to and is actuated by the filter saturation controller 20, which receives the signal associated with the weight of the VOC filter 12.

A weight calculator 24 is connected to the filter saturation controller 20. The weight calculator 24 calculates the weight and the increase in weight of the VOC filter over a time value, from the weight signal data and the time data provided by the filter saturation controller 20. The weight increase is in theory proportional to the weight of VOCs absorbed by the VOC filter 12.

The weight calculator 24 stores tabulated data enabling same to evaluate the weight and weight increase from the weight signal data (e.g., in the form of an electric signal of related magnitude) and the time value.

A benchmark database 26 is associated with the controller 20. The benchmark database 26 stores data pertaining to filter use (e.g., theoretical and archived weight and weight increase rate values, average weights, a benchmark clean weight for the VOC filter). For example, the theoretical weight of the VOC filter 12 up to saturation is stored in the benchmark database 26, as a preset operating value of the filtering apparatus. Therefore, a comparison of the actual weight, as calculated by the weight calculator 24, and the theoretical weight at saturation or the clean weight, as provided by the benchmark database 26, is performed by a saturation interpreter 28.

The saturation interpreter 28 is connected to the controller 20. The saturation interpreter 28 receives the actual weight data, from the weight calculator 24, as well as a benchmark weight (e.g., the theoretical weight at saturation, the clean weight), from the benchmark database 26. The comparison between the two values by the saturation interpreter 28 provides a level of saturation, in addition to indicating whether the filter 12 is saturated.

Optionally, the saturation interpreter 28 also ensures that the weight increase truly indicates a saturation of the filter 12. By receiving the weight increase rate from the weight calculator 24, the saturation interpreter 28 can detect unusual rate increases. Such an unusual rate increase may result from tools or like additional weight being temporarily disposed on the filtering apparatus. The sudden increase is therefore taken into account by the saturation interpreter 28.

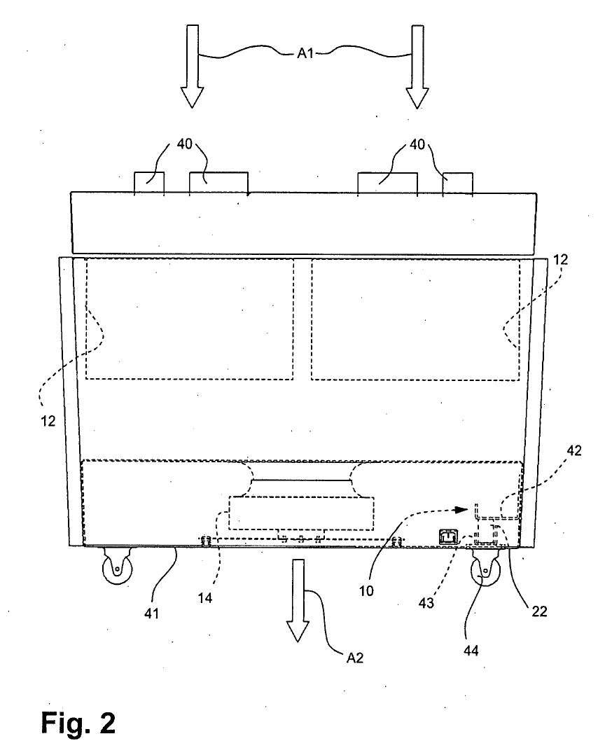

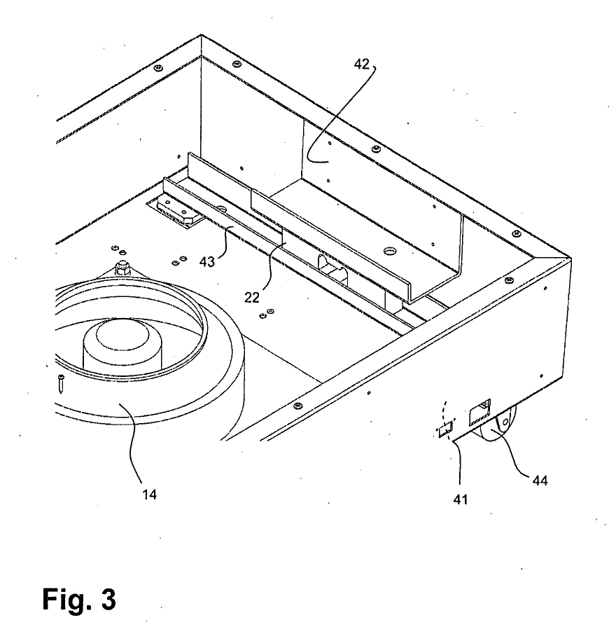

This feature is particularly useful in a specific configuration of the filtering apparatus, such as the one described hereinafter in FIGS. 2 and 3. The actual weight increase rate is provided by the weight calculator 24, and is compared by the saturation interpreter 28 with archived and/or theoretical weight increase rates, as provided by the benchmark database 26. Moreover, the weight increase rates as well as the weight are optionally archived to the database 26, for future reference/comparison purposes.

With this information, it is also possible for the saturation interpreter 28 to determine whether the filtering apparatus is on the verge of being operated without any filter 12. In such a case, the controller 20 may prevent the actuation of the flow inducer 14 as a function of signaling from the saturation interpreter 28.

Interfaces 30 are connected to the filter saturation controller 20, to provide signals to the attendant of the filtering apparatus. More specifically, from the saturation level signaling of the saturation interpreter 28, the filter saturation controller 20 informs the attendant of the filtering apparatus of the level of saturation of the filter, through the interfaces 30.

As an example, visual indicators such as a plurality of LEDs arranged in a LED graph-bar are provided to indicate the level of saturation, with LEDs of yellow color addressing a warning, and a LED of red color a full saturation. The LEDs may flash to catch the attention of the attendant. All necessary precautions must be taken to avoid the exposure of the attendant to VOC-polluted air. For instance, if the saturation interpreter 28 detects a full saturation of the filter 12, the controller 20 may automatically shut the flow inducer 14 off. The interfaces 30 may also have sound signals to alarm the attendant of the saturation of the filter 12. Upon saturation, the interface 30 may also send a signal or interlock contact to automatically shut down the device or process that is generating the VOCs.

It is contemplated to provide the interfaces 30 with a reset button to be pressed to indicate to the filter saturation controller 20 that the filter 12 has been replaced. Accordingly, a tare of the new filter may be performed upon the reset by the attendant, and a benchmark weight may be stored in the benchmark database 26, through the combined operation of the weight sensor 22 and the weight calculator 24, as controlled by the controller 20. Alternatively, the tare/reset may be performed by a switch being automatically triggered by the replacement of the filter 12. Whichever method is used to tare/reset, the controller may compare the weight with the previous filter to determine that a new filter has been installed.

Referring to FIG. 2, an example of a filtering apparatus with which the filter saturation control system 10 may be used is shown with the VOC filters 12 at an upper end, and the flow inducer 14 at a bottom end. Inflow A1 passes through the inlets 40, which are typically connected to hoses/pipes positioned at the source of VOCs (e.g., fume hood). The outflow A2 exits from a bottom surface 41 of the filtering apparatus.

The weight sensor 22 is a load cell upon which a part of the weight of the filtering apparatus rests. More specifically, as shown in FIG. 3, a bracket 42 interconnects the weight sensor 22 on an inner wall of the filtering apparatus. One of the many types of load cells considered for use as the weight sensor 22 is a low profile two-beam single point load cell. Other types of load cells and mounting arrangements are possible and considered.

A balance bar 43 is also secured to the weight sensor 22. Casters 44 are at opposed ends of the balance bar 43. Therefore, a portion of the weight of the filtering apparatus rests on the weight sensor 22, by way of the balance bar 43 and the casters 44.

Therefore, an increase of weight of the filtering apparatus resulting from the absorption of VOCs by the VOC filter 12 will be detected by the weight sensor 22.

On the other hand, the filtering apparatus presents a flat surface at a convenient height, which may result in this flat surface serving as a support for objects. In such a case, the measure and comparison of weight increase rates ensures that such weight variation will not impede with the operation of the filtering apparatus.

1. A system to determine a level of saturation of a VOC filter in a filtering apparatus, comprising:
a weight sensor to produce a weight signal associated with the VOC filter;
a weight calculator connected to the weight sensor, the weight calculator providing an actual weight of the VOC filter from the weight signal;
a database storing benchmark weight for the VOC filter; and
a saturation interpreter connected to the weight calculator to determine a saturation level of the VOC filter as a function of the actual weight of the VOC filter and a benchmark weight;
whereby the system indicates a saturation level for the VOC filter.

2. The system according to claim 1, wherein the weight signal provided by the weight sensor is related to the weight of the filtering apparatus.

3. The system according to claim 2, wherein the weight sensor is a load cell positioned between the VOC filter and the ground.

4. The system according to claim 1, wherein the weight calculator provides weight increase rate measurements, and the saturation interpreter determines with the weight increase rate measurements whether a weight increase is associated with an increase in saturation of the filter.

5. A system for determining a level of saturation of a VOC filter in a filtering apparatus, comprising:
a weight sensor for sensing a weight of at least a portion of the filtering apparatus including the VOC filter and for producing a corresponding weight signal;
a weight calculator for determining an actual weight of the VOC filter based on the weight signal and for producing corresponding actual weight data;
a saturation interpreter for determining the level of saturation of the VOC filter based on a comparison between the actual weight data and benchmark weight data; and
an interface for providing an indication of the level of saturation.

6. The system according to claim 5, wherein the weight sensor is also adapted to sense a weight of the VOC filter upon installation and to produce a reference weight signal becoming part of the benchmark weight data.

7. The system according to claim 5, further comprising a controller for activating the system only when a flow of air through the filtering apparatus is turned on.

8. The system according to claim 7, wherein the controller is further adapted to prevent the flow of air through the filtering apparatus when the saturation interpreter indicates that the level of saturation equals at least a predetermined value.

9. The system according to claim 5, further comprising a controller interconnecting the weight sensor, the weight calculator, the saturation interpreter and the interface.

10. The system according to claim 9, wherein the controller is associated with a database storing the benchmark weight data.

11. The system according to claim 5, wherein the actual weight data includes an actual weight increase for a given period of time and the benchmark weight data includes an expected weight increase for the given period of time, the saturation interpreter being adapted to compare the actual weight increase with the expected weight increase to determine whether the actual weight increase is entirely due to an increase in the level of saturation.

12. The system according to claim 11, further including a database, and the saturation interpreter is adapted to archive the weight data in the database for future determination of the expected weight increase.

13. The system according to claim 5, wherein the weight sensor is a load cell positioned under the VOC filter.

14. A method of determining a saturation level of a VOC filter in a filtering apparatus, the method comprising:
measuring an actual weight of the VOC filter;
computing an actual weight difference between the actual weight and a benchmark weight; and
determining the saturation level based on the actual weight difference.

15. The method according to claim 14, wherein the benchmark weight includes one of a clean weight and a saturated weight of the VOC filter.

16. The method according to claim 14, wherein measuring the actual weight of the VOC filter includes weighing at least a portion of the filtering apparatus including the VOC filter.

17. The method according to claim 14, further comprising, before determining the saturation level, comparing the actual weight difference with an expected weight difference to determine whether the actual weight difference is entirely due to an increase in the saturation level.

18. The method according to claim 14, further comprising determining if a flow of air is circulated through the filtering apparatus before measuring the actual weight.

19. A filtering apparatus comprising:
a body defining an inlet and an outlet;
a flow inducer inducing an airflow in the body from the inlet to the outlet;
a VOC filter located in the body such that the airflow circulates therethrough;
a weight sensor measuring a weight of at least a portion of the filtering apparatus including the VOC filter and providing a corresponding weight measurement;
a system determining a saturation level of the VOC filter based on the weight measurement; and
an interface providing an indication of the saturation level.
